(19) United States
(12) Patent Application Publication
(10) Pub. No.: US 2026/0222202 A1
(43) Pub. Date: Jul. 30, 2026

(54) Hardware Security System for Preventing Side Channel Attacks Based on Variable Radix

(71) Applicant: Intelligent Information Security Technology Inc., Hsinchu (TW)

(72) Inventors: Wai-Chi Fang, Hsinchu (TW); Yang Yang, Hsinchu (TW)

(21) Appl. No.: 19/315,676

(22) Filed: Sep. 1, 2025

Related U.S. Application Data
(60) Provisional application No. 63/749,010, filed on Jan. 24, 2025.

(51) Int. Cl. H04L 9/30; G06F 21/75; H04L 9/32

(52) U.S. Cl. CPC H04L 9/3066; G06F 21/75; H04L 9/3278

(57) ABSTRACT

The present invention discloses a hardware security system for prevent side channel attacks based on a variable radix. The system comprises a security chip and a fuzzy elliptic curve multiplication module. The security chip uses a PUF array to generate a digital fingerprint as the root key, stabilized by a dedicated module, while unstable bits serve as a true random number source. A top controller manages encryption and decryption operations. The key computation unit includes a variable radix processor that decomposes the private key into symbol-radix pairs for conversion into a variable-radix system. An operation sequence module translates the output into high-order-first elliptic curve instructions, leveraging the distributive property for optimization. A dummy insertion module ensures uniform execution time to resist timing analysis. The elliptic curve module performs point addition and multiplication accordingly, enhancing resistance against timing, power, and differential attacks.

### CROSS REFERENCE TO RELATED APPLICATIONS

The present application claims the benefit of U.S. Provisional Ser. No. 63/749,010 filed on Jan. 24, 2025, the contents of which are incorporated herein by reference in their entirety.

### TECHNICAL FIELD

The present invention relates to a hardware security system based on a variable radix to prevent side channel attacks, and more particularly to an elliptic curve multiplication algorithm utilizing a variable radix. It also provides a hardware architecture designed to accommodate the computational requirements of the variable radix system, aiming to prevent side channel attacks.

### BACKGROUND

With the growing demand for information security, applications related to data confidentiality and identity authentication have increased significantly. To protect personal privacy, prevent the leakage of confidential information, and establish a trustworthy information environment, it is crucial to develop a robust security system. Such a security system must not only include efficient and reliable communication protocols and encryption algorithms but also be supported by corresponding hardware architectures to meet the performance and security requirements of diverse application scenarios.

In recent years, cyberattack techniques have evolved from merely exploiting logical vulnerabilities in algorithms to incorporating physical attack methods at the hardware level. Attackers attempt to infiltrate hardware devices through various means in order to access or steal confidential information. Therefore, when designing hardware security systems, it is essential not only to ensure compliance with existing protocols and algorithm specifications but also to equip the system with the capability to resist various forms of physical attacks. Common physical attack methods include directly observing the structural characteristics of a chip or even intruding into the chip to obtain key information, thereby compromising the system's Root of Trust. Another, more covert type of attack is the Side Channel Attack (SCA), which involves analyzing physical signals generated during chip computations, such as power waveforms, electromagnetic emissions, or processing delays to infer key information and ultimately leak confidential data.

In view of the foregoing, to overcome the aforementioned drawbacks, the inventor has devoted considerable research efforts and resources, continuously making breakthroughs and innovations in the field. Accordingly, the inventor has designed a low-power, high-security protocol capable of addressing the above issues and ensuring effective operation in dynamic and distributed IoT environments.

### SUMMARY

The main objective of the present invention is to provide a hardware security system capable of resisting side channel attacks, with its core design based on a Variable Radix defense mechanism. Through the use of a variable radix architecture, the present invention effectively disrupts the possibility for external attackers to establish a correlation between private key bits and computational operations. In particular, against Differential Power Analysis (DPA) attacks, the invention blocks attempt to perform statistical inference and key reconstruction through power waveform analysis of the computation process, thereby significantly enhancing the system's resistance to DPA and other side channel attacks. Furthermore, the proposed Variable Radix Elliptic Curve Multiplication (ECM) architecture of the present invention is capable of defending against various forms of Side Channel Attacks (SCA). The architecture not only prevents standard power analysis attacks but also provides reinforced protection mechanisms against more advanced attack techniques such as Differential Side-Channel Attacks (DSCA).

To achieve the above-mentioned objective, the present invention provides a hardware security system based on a variable radix to prevent side-channel attacks, comprising: a security chip and a fuzzy elliptic curve multiplication module. The security chip includes: a PUF (Physically Unclonable Function) processing module, an encryption module, and a communication interface. The PUF processing module comprises a PUF array, an adaptive stabilization module, a true random number generator (TRNG), and a PUF source controller. The PUF array generates a digital fingerprint as one of the root keys; the adaptive stabilization module extracts and stabilizes the digital fingerprint generated by the PUF array; the PUF source controller is communicatively connected to the PUF array, the adaptive stabilization module, and the TRNG, and controls the overall operation of the PUF processing module, wherein certain unstable PUF cells can serve as the entropy source for the TRNG. The encryption module is communicatively connected to the PUF processing module through a top controller, and includes hash functions, key and random number expansion functions, and both symmetric and asymmetric encryption/decryption mechanisms. The communication interface is communicatively connected to the encryption module through the top controller and is used to transmit information between the security chip and an external user.

Furthermore, the variable radix elliptic curve multiplication module is configured within the security chip and comprises: a variable radix processor, an operation sequence module, an insertion module, and an elliptic curve module. The variable radix processor decomposes a private key value into a set of symbols and radix values, converting the private key into a variable radix system algorithm. This allows the determination of the bit value of each digit, serving as the foundational basis for subsequent private key operations. The operation sequence module converts the set of symbols and radix values into an operation indicating an elliptic curve multiplication. It adopts a Most Significant Place Value (MSPV) strategy, prioritizing the processing of the higher-order symbol and the radix value. Intermediate computation results are temporarily stored, and during subsequent lower-order elliptic curve multiplication operations, a distributive property is applied such that only a single multiplication is required to complete the multiplication involving the high-order components. The insertion module ensures that the length of the operation sequence remains fixed, thereby making the computation time for each public key generation nearly constant. The insertion module checks the actual length of the sequence and, if it is shorter than a predefined length, randomly inserts obfuscation operations until the target length is reached. These obfuscation operations are not written into any registers and do not participate in subsequent computations, ensuring that they do not affect the final result of the elliptic curve computation. The elliptic curve module performs point multiplication and point addition operations on the elliptic curve based on the content of the operation instructions. The base point of the elliptic curve is defined as a generator point G, which is continuously updated during the distributive property computation process and used as an input parameter for the point addition operations.

### BRIEF DESCRIPTION OF THE DRAWINGS

FIG. 1 is a schematic diagram of a security chip based on a variable radix for preventing side channel attacks according to the present invention.

FIG. 2 is a schematic diagram of a structure of a PUF array according to the present invention.

FIG. 3 is a schematic diagram of a variable radix elliptic curve multiplication module according to the present invention.

FIG. 4 is a schematic diagram of a variable radix processor according to the present invention.

FIG. 5 is a schematic diagram illustrating the operations of the elliptic curve module according to the present invention.

### DETAILED DESCRIPTION

In order to enable a person skilled in the art to better understand the objectives, technical features, and advantages of the invention and to implement it, the invention is further elucidated by accompanying appended drawings. This specifically clarifies the technical features and embodiments of the invention, and enumerates exemplary scenarios. To convey the meaning related to the features of the invention, the corresponding drawings herein below are not and do not need to be completely drawn according to the actual situation.

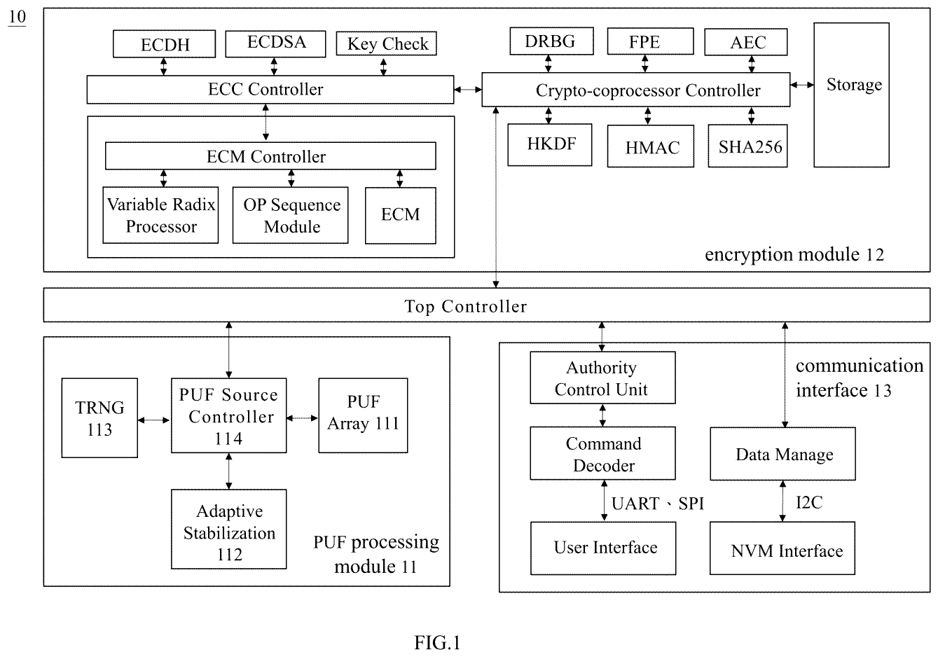

Please refer to FIG. 1, FIG. 1 is a schematic diagram of a security chip based on a variable radix for preventing side channel attacks according to the present invention.

As shown in FIG. 1, the present invention provides a hardware security system for preventing side channel attacks based on variable radix. The system includes: a security chip 10 and a fuzzy elliptic curve multiplication module 20. The security chip 10 comprises: a PUF processing module 11, an encryption module 12, and a communication interface 13. The PUF processing module 11 includes a PUF array 111, an adaptive stabilization module 112, a true random number generator (TRNG) 113, and a PUF source controller 114. The PUF array 111 generates a digital fingerprint used as one of the key roots; the adaptive stabilization module 112 performs extraction and stabilization processing on the digital fingerprint generated by the PUF array 111; the PUF source controller 114 is communicatively connected to the PUF array 111, the adaptive stabilization module 112, and the true random number generator 113, and controls the overall operation of the PUF processing module 11, wherein some unstable PUF cells can be used as entropy sources for the true random number generator 113.

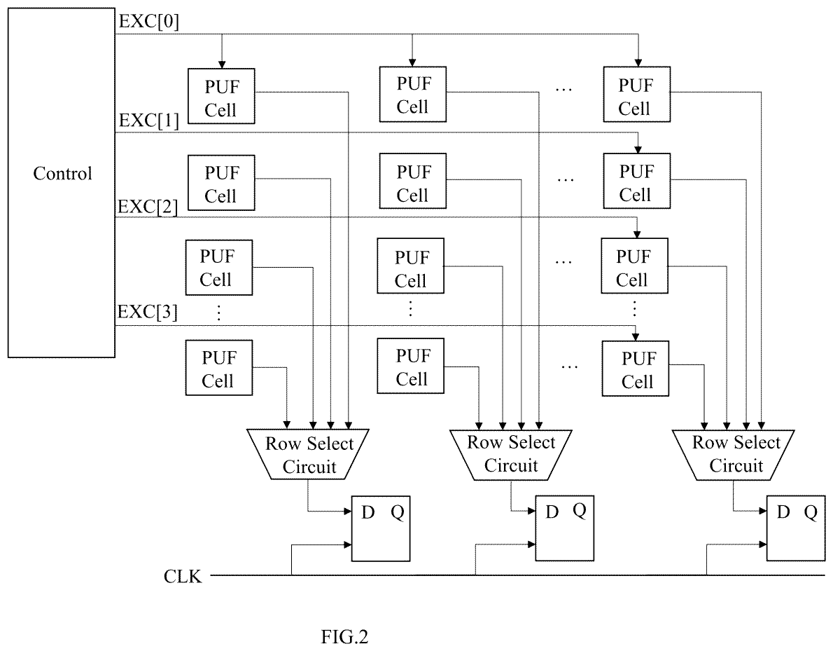

Please refer to FIG. 2, FIG. 2 is a schematic diagram of a structure of a PUF array according to the present invention.

As shown in FIG. 2, in order to implement PUF-based device fingerprint recognition and random number generation, the present invention provides a physically unclonable function (PUF) array architecture with high entropy and uniqueness. The structure of the PUF entropy array consists of 800 PUF cells, control circuits for stimulus signals, an OR Gate logic-based row select control, column registers, and counters. The PUF entropy array consists of 25 rows and 32 columns, with each row containing 32 PUF cells and each column containing 25 PUF cells. During each clock cycle, one row of the PUF array 111 is selectively stimulated, and the corresponding extraction circuits retrieves data, which is then subjected to logic operations to generate a 32-bit digital output. By applying multiple stimulations, the PUF cells are classified into a stable unit or an oscillatory unit. The stable unit is utilized to generate a unique device fingerprint, while the oscillating unit serve as a high-quality entropy source for random number generation. The architecture enhances the security and identifiability of the PUF array 111 while optimizing hardware resource consumption and data throughput.

The true random number generator (TRNG) 113 produces random numbers that cannot be derived through algorithms. Compared to a deterministic random bit generator (DRBG), the main difference lies in the generation method: DRBG generate random numbers through algorithms, offering higher efficiency and relatively unpredictable output, but they are essentially reproducible. In contrast, TRNGs produce inherently unpredictable and non-reproducible random numbers, making them highly suitable as entropy sources for DRBGs. Since most physically unclonable function (PUF) units are stable and produce fixed outputs, it is necessary to filter out those units that exhibit physical randomness for use in random number generation. The TRNG 113 first stimulates the PUF array 120 times to identify units with higher randomness, then repeatedly stimulates the selected units to extract outputs. Once the accumulated output data meets a predefined threshold, all outputs are summed, and the last two bits of the sum are taken as the final random number. To improve processing efficiency, the TRNG 113 utilizes four buses to perform parallel processing.

Moreover, the deterministic random bit generator (DRBG) is designed to efficiently and securely generate a large volume of random numbers. In accordance with the NIST SP 800-90Ar1 standard, the DRBG generates pseudorandom numbers based on a seed and internal stat, and is capable of reproducing the same output under identical conditions. The security of the DRBG relies on two main requirements: Backtracking Resistance and Prediction Resistance. Backtracking Resistance ensures that even if the current state is compromised, an attacker cannot deduce the previous internal states from the available information. Prediction Resistance ensures that the attacker cannot predict future internal states or outputs based on leaked information. To meet these security requirements, the DRBG employs a hash function to process internal states and outputs, and performs periodically reseed to introduce fresh entropy and prevent attackers from deducing the pseudorandom number generation pattern. The DRBG system is based on a finite state machine (FSM) and performs three main functions: initialization, random number generation, and entropy reseeding. During the initialization phase, the system acquires entropy input from the true random number generator based on a PUF entropy array, and uses a hash derivation function to generate an initial seed and initialize the internal state. In the random number generation phase, the DRBG generates pseudorandom numbers based on the current internal state and updates the until state a reseed counter reaches a preset threshold. At that point, the internal state is updated with a new entropy source, and random number generation continues. Periodic entropy reseeding effectively reduces the risk of over-reliance on a single seed, ensuring that the generated random numbers remain secure and unpredictable.

Next, the encryption module 12 is communicatively connected to the PUF processing module 11 via a top controller 14. The encryption module 12 includes a hash function, key and random number expansion functions, and both symmetric and asymmetric encryption and decryption mechanisms. SHA-256 is a one-way hash function that generates a fixed-length output from a given input, making it computationally infeasible to reverse-engineer the original input. HMAC enhances the hash function by incorporating a key into the input, allowing both parties in secure communication to generate the same authentication code using a shared key. The HMAC-based Key Derivation Function (HKDF) is a key expansion function based on HMAC, capable of efficiently generating a large number of derived keys from a small amount of key material produced by the PUF array 111 or from shared secrets in symmetric encryption. The approach prevents the direct use of limited secret key material in applications, thereby protecting the root of trust of the entire hardware security system while enhancing both security and efficiency. HKDF consists of two main steps: extraction and expansion. In the extraction step, the secret key source is processed using HMAC to produce an initial key derivation material. In the expansion step, HMAC is used again to generate the final derived keys. To further enhance security, HKDF introduces a layered structure that increases isolation between the key source and the final keys. If a key at a certain layer is compromised, only that the affected layer needs to be re-derived. Additionally, users can specify the desired hierarchy level for continued key derivation, improving flexibility and usability

The encryption methods include a symmetric encryption (AES, FPE) and an asymmetric encryption (ECC). The symmetric encryption offers faster computation but requires both parties to share the same key. The asymmetric encryption uses a public key for encryption and a private key for decryption. Although it involves more computation, it provides secure key exchange and digital identity authentication without the need for key sharing. Therefore, using asymmetric encryption to transmit the shared key required for symmetric encryption, and then using symmetric encryption for efficient confidential message transmission, is a balanced approach that ensures both security and efficiency.

Furthermore, the communication interface 13 is communicatively connected to the encryption module 12 via the top controller 14 and is used to transmit information between the secure chip 10 and an external user. The communication interface 13 receives external data, including a private key and a seed, and transmits them to the fuzzy elliptic curve multiplication module 20. The seed is processed by a pseudorandom number generator (PRNG) to generate multiple random values, which serve as sources for subsequent variable radix. The private key is transmitted to the fuzzy elliptic curve multiplication module for further processing.

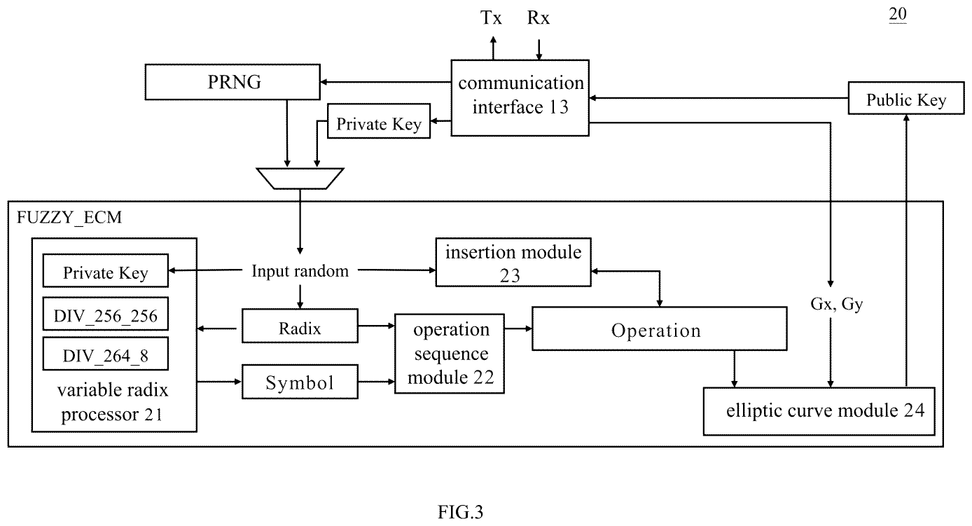

Please refer to FIG. 3, FIG. 3 is a schematic diagram of a fuzzy elliptic curve multiplication module according to the present invention.

As shown in FIG. 3, the Fuzzy Elliptic Curve Multiplication (FUZZY ECM) module 20 is configured within the secure chip 10 and includes a variable radix processor 21, an operation sequence module 22, an insertion module 23, and an elliptic curve module 24. In the FUZZY ECM module, random radix is used to decompose the private key, thereby disrupting the elliptic curve cryptographic computation process. The obfuscates side channel attacks (such as power consumption, temperature variation, and timing analysis), making it difficult for attackers to deduce the private key from such signals, and thus enhances resistance to side channel attacks (SCA). In the FUZZY ECM module, the sequence of point multiplication and point addition operations is no longer directly determined by the bits of the private key. Instead, the private key is decomposed based on random base points, and the corresponding ECC point multiplication and point addition operations are performed, ultimately calculating the corresponding public key. Once the computation is complete, the public key is transmitted to the external entity via the communication interface 13.

The variable radix processor 21 decomposes a private key value into a combination of a symbol and a radix, converting the private key into a variable radix algorithm to determine the bit value of each digit, which serves as the foundational basis for subsequent private key operations. Upon receiving the private key and radix, the variable radix processor 21 uses multiple random radix values to decompose the private key and calculates, through a divider, the number of radix multiplications required to convert the private key into symbols.

In the present invention, “variable radix” refers to converting a private key from a traditional fixed-radix system into a variable radix system. A variable radix, also known as variable base, means that the positional base differs for each digit. For example, one digit may use hexadecimal (radix 16), while the next uses decimal (radix 10). After the private key is converted from a fixed-radix system to a variable-radix system, it becomes a set of symbols and radix values. The radix refers to the positional base, indicating the range for carrying, while the symbol represents the numeric symbol for that digit. It is evident that the computation processes between the two numeral systems are different. The positions of point double and point addition operations change entirely and cannot be easily located or analyzed. Since the radix values are generated by an internal random number generator, external observers cannot deduce the relationship between the private key and its corresponding symbols and bases. Consequently, the operation sequence based on variable radix transformation differs completely from the double-and-add sequence used in fixed-radix systems.

To convert a number into a variable-radix system, it is necessary to first determine the place value of each digit, which serves as the basis for subsequently distributing the private key value across the various digit positions. The concept of place value refers to the fact that a numeral has different magnitudes depending on its position. For example, in the decimal number 2017, the digit “2” does not represent just two, but two thousand, this means the numeral “2” must be multiplied by one thousand. Here, “2” is the symbol, and “one thousand” is the place value. Each digit's place value is the product of the radixes (bases) of all less significant digit positions. To establish the place values for each digit, a cumulative multiplication of the radixes must be performed. In the variable radix processor 21, this cumulative multiplication continues until the resulting product exceeds the private key value. This ensures that the place values are sufficient to fully represent the private key. In a variable-radix system, the value of each digit is the product of the digit itself and its corresponding place value. Specifically, each digit's place value is obtained by multiplying the radix of the previous digit by the place value of the previous digit. In other words, a digit's place value is the cumulative product of the radixes of all less significant digits.

After determining the maximum place value, the hardware security system begins from the most significant digit and divides the private key value by the place value of the current digit. The resulting quotient is used as the output symbol for that digit, while the remainder becomes the portion of the private key that has not yet been allocated. This remainder is then used in the calculation for the next digit by dividing it by the next digit's place value. Subsequently, the place value is also divided by the radix (base) of the current digit to update the place value for the next digit. The process starts from the most significant digit and continues down to the least significant digit. The method enables accurate calculation of each digit's value without any carry errors and ensures that the sum of all digits multiplied by their respective place values equals the original private key value.

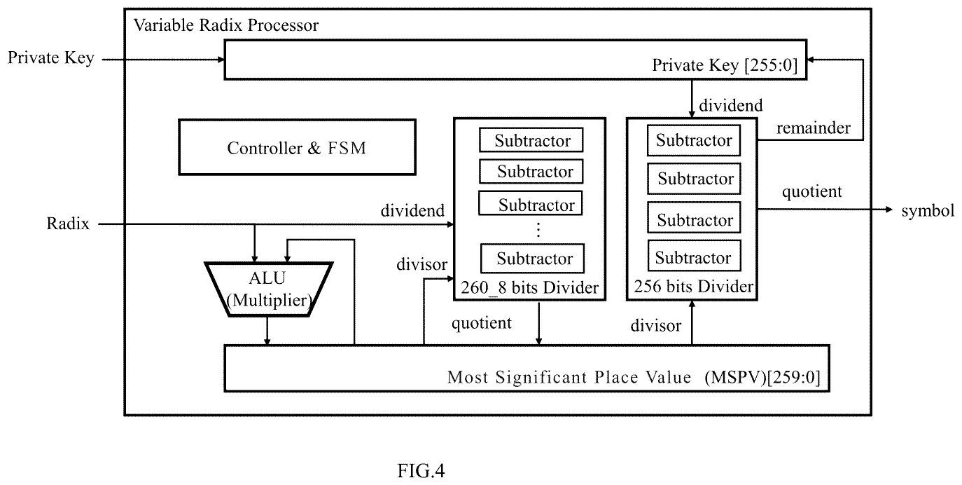

Please refer to FIG. 4, FIG. 4 is a schematic diagram of a variable radix processor according to the present invention.

As shown in FIG. 4, before finding a sufficiently large bit value, a Finite State Machine (FSM) controls a multiplier to perform cumulative multiplication operations. After confirming the place value, the FSM controls two dividers to continuously update the place value and the private key, and calculates the corresponding symbol.

The operation sequence module 22 converts the set of the symbol and the radix into an operation indicating an elliptic curve multiplication. It adopts a high-order-first strategy to process the higher-order symbol and the higher-order radix first, temporarily storing the intermediate result. When the lower-order bits subsequently participate in the elliptic curve multiplication, a distributive property is applied so that the multiplication operation involving higher-order information can be completed with only a single multiplication. The processing strategy directly impacts the number of operations required, thereby influencing the overall computational efficiency. The symbol must be multiplied by its corresponding bit value to represent its actual magnitude. If each bit is considered separately, every bit would require a multiplication with the least significant radix. The key to reducing computational load lies in finding a method that allows each radix to be used in only one multiplication, rather than having every bit participate in the computation.

After confirming all the required operation instructions, the symbol and the radix can be arranged into an operator sequence for indicating elliptic curve multiplication, using the distributive property form proposed in the present invention. To enhance computational efficiency, the present invention establishes a double-and-add library. When the symbol and radix need to be converted into an operation sequence, the hardware security system can directly access the double-and-add library to obtain a predefined sequence of operation instructions, thereby reducing the need for real-time computation.

In Elliptic Curve Cryptography (ECC), numbers are represented through sequences of point double (D) and point addition (A). For example, the sequence “DA” represents one doubling followed by one addition, corresponding to the value 3; “DD” represents two doublings, corresponding to the value 4. Convert the symbol and the radix into the corresponding operation sequence based on the double-and-add library, thereby reducing the need for real-time computation. During the computation process, each symbol is followed by a multiplication operation (3′b010), and each radix is followed by an addition operation (3′b011), forming a regular processing flow. To prevent side channel attacks, the operation sequence module 22 is fixed to perform 690 operations, ensuring that each ECM computation has the same execution time and number of operations. This reduces the risk of attackers inferring the private key through timing or power analysis. If the number of operations exceeds 690, the operation sequence module 22 will cease execution, prompt for a private key update, and restart the computation process.

The insertion module 23 ensures that the length of the operation instruction sequence is fixed, so that the computation time required for each public key generation becomes consistent. The insertion module 23 checks the actual length of the sequence and, if it does not reach a predefined length, randomly inserts dummy operations until the target length is achieved. These dummy operations are neither written to a register nor involved in subsequent computations, ensuring they do not affect the final elliptic curve computation result. The insertion module 23 follows three objectives: the first is to ensure that the time required for each elliptic curve multiplication to compute the public key remains relatively consistent. The objective is achieved by ensuring that the total number of operation instructions is fixed. The second objective is to mask power characteristics by inserting dummy operations to obscure the power signature. The third objective is to ensure that the dummy operations do not affect the computation result, as they are not stored in registers and therefore do not participate in the calculation process.

The elliptic curve module 24 performs point double and point addition operations on the elliptic curve based on the contents of the operations. The base point of the elliptic curve is defined as a generator point (G). During the distributive property computation process, the generator point G is continuously updated and used as an input parameter for the point addition operation.

To support the requirements of distributive property computation, an adjustable base point is introduced in elliptic curve multiplication, along with the definition of various operations and their corresponding execution processes. The operations can be categorized into three types. The first type includes the traditional point double and point addition operations used in elliptic curve multiplication. The second type consists of operations defined to support the distributive property, specifically the Load and Multiply operations. The third type comprises dummy operations used to obscure power waveforms, referred to as Dummy Operations. In elliptic curve multiplication, the base point P serves as the starting point of the computation and as the input parameter for subsequent point addition operations. In traditional elliptic curve multiplication, the input parameter for point addition is always the fixed base point P. In the elliptic curve multiplication of the present invention, however, the base point P is only the starting point. The Load and Multiply operation symbols modify the input parameter for point addition, referred to as the Generator Point, to align with the distributive property.

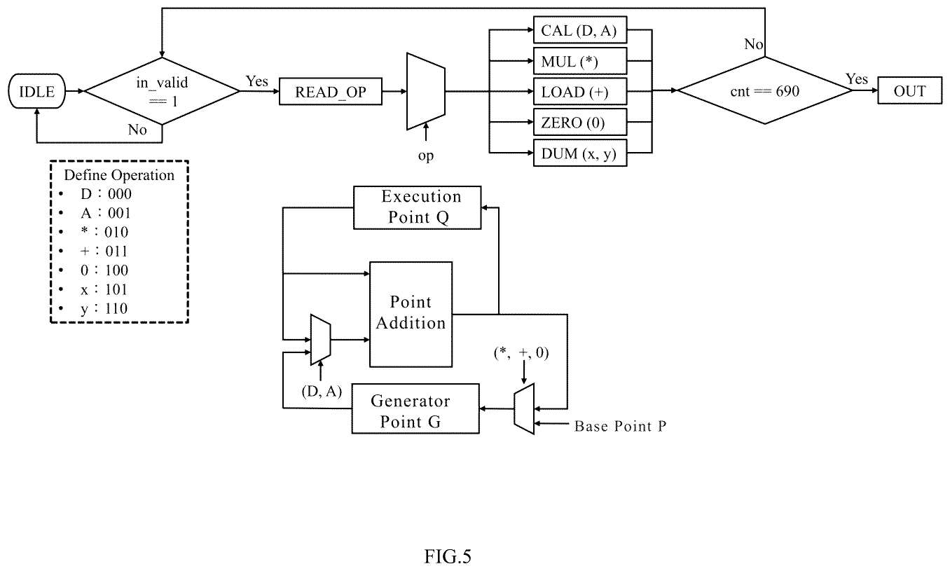

Please refer to FIG. 5, FIG. 5 is a schematic diagram illustrating the operations of the elliptic curve module according to the present invention.

As shown in FIG. 5, the state machine flow of the elliptic curve module 24 begins in the IDLE state, waiting for a signal. It then transitions to the READ_OP state to read the operation sequence and sequentially executes the corresponding computation states (such as MUL, LOAD, ZERO, etc.). The process repeats until 690 operations are completed, after which a 256-bit public key is output, and the system returns to the IDLE state. The elliptic curve module 24 allows users to input a predefined base point P to perform point doubling and point addition operations on the elliptic curve. In ECM, the components include the base point P, the generator point G, and the execution point Q, where Q represents the current computation position, and G is a multiple of the base point P. In the elliptic curve module 24, using a new multiplication operator (*) and load operator (+) combined with the distributive property, G is dynamically updated to a multiple of P based on computation requirements. The point double and point addition operations are performed through a point addition module, eliminating the need for a dedicated point multiplication module.

When the point addition module receives a point double operation, it computes the tangent line at the current execution point Q, determines its intersection with the elliptic curve, and takes the point symmetric to the intersection point about the x-axis as the doubling result. It then updates the execution point Q for use in subsequent computations. When the point addition module receives a point addition operation, it connects the execution point Q with the generator point G, computes their intersection with the elliptic curve, and takes the point symmetric to the intersection point about the x-axis as the addition result. The execution point Q is then updated for use in further computations.

When the point addition module receives a Load operation, it stores the current execution point Q and resets the generator point G to the base point P. The stored execution point Q will be used in subsequent Multiply operations for point addition and to compute the updated generator point G. Additionally, when the point addition module receives a Zero operation, it stores the current execution point Q and resets both the generator point G and the execution point Q to the origin (0,0). The stored execution point Q will also be used in subsequent Multiply operations to compute the updated generator point G.

During a Multiply operation, the previously stored execution point Q (from the Load or Zero operation) and the current execution point Q are input into the point addition module to perform a point addition. The newly computed elliptic curve point is then used to update both the execution point Q and the generator point G. Subsequent point addition and point doubling operations will use this new point as the generator point G until the next Load operation occurs. The essence of the Multiply operation is to evaluate the expression up to the current stage and consolidate all previously executed values within parentheses (i.e., the generator point G). Numbers that require multiplication afterward will be converted into a sequence of doubling and addition operations. Therefore, to align with the distributive property on the left side of the expression, the input parameter for point addition must be updated to the generator point.

The present invention aims to address various types of side channel attacks. Representative types of such attacks include Timing Attack (TA), Simple Power Analysis (SPA), Differential Power Analysis (DPA), Doubling Attack, and Zero Point Attack.

To verify the effectiveness of the present invention against side channel attacks, the Xilinx CW305 Artix FPGA target chip was used, and programming and physical circuit functional verification were performed via the Vivado platform. Side channel attack analysis and simulation were conducted using the ChipWhisperer platform developed by NewAE. Within the testing environment, Timing Attack (TA), Simple Power Analysis (SPA), Differential Power Analysis (DPA), Doubling Attack, and Zero Point Attack were executed in an attempt to recover the cryptographic key. Failure to recover the key would validate the effectiveness of the proposed hardware security system in mitigating side channel attacks.

To evaluate the protective effectiveness of the d hardware security system's variable radix ECM of the present invention, a comparison was made between the performance of traditional ECM and variable radix ECM under various side channel attacks. The comparison demonstrates the resistance of the variable radix ECM to such attacks. In a DPA (Differential Power Analysis) attack on traditional ECM, an attacker can utilize a specially crafted key, e.g., with the first 128 bits set to 0 and the subsequent 128 bits set to 1, to generate predictable waveform differences. By collecting and comparing multiple power traces, the attacker can accurately distinguish the power characteristics of 0 and 1 bits, allowing a threshold to be set for identifying each bit of the key. Even if the key is composed of random bits, the attacker can achieve 100% key recovery.

The protective effectiveness of the variable radix ECM used in the present invention lies in transforming traditional key bits into the combination of symbol and radix, resulting in unpredictable operation sequences. The hardware security system of the present invention incorporates the following countermeasures: the order of operation sequences varies depending on the key transformation, making it difficult to infer; random dummy operations are inserted to maintain a fixed operation length and disrupt power traces; and all keys are executed over a fixed 690 operations to resist timing analysis attacks. Furthermore, DPA attacks cannot infer the timing of point addition or point doubling operations from the power traces of the variable-radix ECM. Even if an attacker can distinguish between point addition and point doubling, the randomly inserted dummy operations obscure the actual execution sequence. Compared to traditional ECM, the variable-radix ECM offers enhanced security and resistance against various side-channel attacks, including DPA, SPA, and timing analysis.

In order to enable the objectives, technical features, and advantages of the invention to be more clearly understood by a person skilled in the art, the invention is further illustrated with the appended drawings, specifically to clarify the technical features and embodiments of the invention and provide better examples. The corresponding drawings below are not, and do not need to be, completely drawn according to the actual situation in order to express the meaning related to the features of the invention.

What is claimed is:

1. A hardware security system for prevent side channel attacks based on a variable radix, comprising:
a security chip, including:
a PUF processing module comprising a PUF array, an adaptive stabilization module, a true random number generator, and a PUF source controller, wherein the PUF array generates a digital fingerprint as a root of a key, the adaptive stabilization module extracts and stabilizes the digital fingerprint generated by the PUF array, and the PUF source controller is communicatively connected to the PUF array, the adaptive stabilization module, and the true random number generator to control overall operations of the PUF processing module, wherein some unstable PUF cells serve as entropy sources for the true random number generator;
an encryption module communicatively connected to the PUF processing module via a top controller, the encryption module comprising hash functions, key and random number expansion functions, and both symmetric and asymmetric encryption/decryption mechanisms; and
a communication interface communicatively connected to the encryption module via the top controller, for transmitting information between the security chip and an external user; and
a variable radix elliptic curve multiplication module disposed within the security chip, comprising:
a variable radix processor configured to decompose a private key into a set of symbols and radix values and convert the private key into an algorithm based on a variable radix system, thereby determining bit values for each digit as a basis for subsequent private key operations;
an operation sequence module configured to convert the set of symbols and radix values into operation indicating elliptic curve multiplication, adopt a high-order-first strategy to process high-order symbol-radix values first, temporarily store intermediate results, and apply a distributive property during subsequent low-order operations so that only one multiplication is required to compute the result that includes high-order information;
an insertion module configured to ensure a fixed length of the operation sequence such that the computation time for each public key generation remains nearly constant, wherein the insertion module checks the actual length of the sequence and randomly inserts dummy operations until a preset length is reached, and the dummy operations neither write to a register nor participate in subsequent operations to ensure that they do not affect the final elliptic curve computation result; and
an elliptic curve module configured to perform point double and point addition operations on the elliptic curve according to the operations, wherein a base point P of the elliptic curve is defined as a generator point G, and the generator point G is continuously updated during the computation process using the distributive property and serves as the input parameter for the point addition operations.

2. The hardware security system according to claim 1, wherein the true random number generator is configured to repeatedly stimulate the PUF array and extract unstable PUF cells to produce a physically-derived entropy source for generating true random numbers, the true random number can be used as a seed for a deterministic random bit generator (DRBG) to generate a large quantity of random number.

3. The hardware security system according to claim 1, wherein the variable radix processor multiplies the radix values cumulatively until the product exceeds the private key value to determine a maximum digit length, starting from the highest digit, it performs division of the private key value by the place value of each digit to obtain the corresponding symbol and remainder, the place value for the next digit is then dynamically updated based on the symbol of the previous digit.

4. The hardware security system according to claim 1, wherein the operation include a point double operation, a point addition operation, a load operation, a multiplication operation, and the dummy operation, wherein the elliptic curve module uses a base point P as the initial generator point during computation, and dynamically updates the value of the generator point G during each load operation or multiplication operation to enable subsequent point addition operations in accordance with the distributive property.

5. The hardware security system according to claim 4, wherein the elliptic curve multiplication further includes an execution point Q indicating the current operation position, and by introducing a multiplication operator (*) and a load operator (+) combined with the distributive property, the generator point G is dynamically updated during computation as a multiple of the base point P according to the corresponding symbol and radix, and the point double and point addition operations are performed through a point addition module.

6. The hardware security system according to claim 5, wherein when the point addition module receives the point double operation, it computes the tangent line at the current execution point Q, finds its intersection with the elliptic curve, takes the point symmetric to the intersection point with respect to the x-axis as the doubling result, and updates the execution point Q for use in subsequent operations.

7. The hardware security system according to claim 5, wherein when the point addition module receives the point addition operation, it connects the execution point Q and the generator point G, calculates their intersection with the elliptic curve, takes the point symmetric to the intersection point with respect to the x-axis as the addition result, and updates the execution point Q for use in subsequent operations.

8. The hardware security system according to claim 5, wherein when the point addition module receives the load operation, it stores the current execution point Q and resets the generator point G to the base point P; the stored execution point Q information will be used in the subsequent multiplication operation for the point addition computation and to calculate the updated generator point G.

9. The hardware security system according to claim 5, wherein when the point addition module receives the reset operation, it stores the current execution point Q and resets both the generator point G and the execution point Q to the origin (0,0); the stored execution point Q information will be used in the subsequent multiplication operation to compute the updated generator point G.

10. The hardware security system according to claim 5, wherein during the multiplication operation, the execution point Q previously stored during the load or reset operation and the current execution point Q are input into the point addition module to perform the point addition operation; the newly calculated elliptic curve point is used to update both the execution point Q and the generator point G, and the subsequent point addition and point multiplication operations will use this new point as the generator point G until the next load operation.
